(19) United States
(12) Patent Application Publication
(10) Pub. No.: US 2004/0147645 A1
(43) Pub. Date: Jul. 29, 2004

(54) System made from a polyamide and a 2,6-diaminopyridine derivative and method for producing of said system

(76) Inventors: Paul-Michael Bever, Neustadt (DE); Gunther Lamm, Hassloch (DE); Bernd-Steffen von Bernstorff, Wachenheim (DE); Christopher William Rieker, Mutterstadt (DE)

Correspondence Address: Keil & Weinkauf, 1101 Connecticut Avenue NW, Washington, DC, 20036, US

(21) Appl. No.: 10/476,858

(22) PCT Filed: May 10, 2002
(86) PCT No.: PCT/EP02/05149

(30) Foreign Application Priority Data
May 15, 2001 (DE) 101 23 733.2
Jan. 15, 2002 (DE) 102 01 403.5

(51) Int. Cl. C08K 5/34

(52) U.S. Cl. 524/99

(57) ABSTRACT

A system comprising

a) a polyamide containing a sterically hindered piperidine derivative attached to the polymer chain by chemical bonding, and

b) a 2,6-diaminopyridine derivative.

The present invention relates to a system comprising

a) a polyamide containing a sterically hindered piperidine derivative attached to the polymer chain by chemical bonding, and

b) a 2,6-diaminopyridine derivative,

and to a process for preparing such a system.

The use of polymers, especially polyamides, for preparing fibers and yarns and the use of such yarns for preparing floor coverings, such as carpets, is common knowledge and described for example in: Ullmann's Encyclopedia of Industrial Chemistry, 5th ed., vol. A10, VCH Verlagsgesellschaft mbH, Weinheim, Germany, 1987, pages 567-579.

Floor coverings are customarily used in dyed form, for example in a solid shade or with a pattern. Any hue is usually the result of using a combination of multiple, such as two or three, dyes.

Existing floor coverings have the disadvantage of fading in the areas exposed to light and the heat due to the light, whereas such fading does not occur in areas shaded by furniture for example. Fading for the purposes of the present invention is any discoloration of the floor covering due to one component of a dye combination suffering a greater loss of color on exposure to light than the other dyes. When for example in a combination of a red dye, a yellow dye and a blue dye the red dye suffers a loss of color to a greater extent on exposure to light than the other dyes, the floor covering will gradually turn greenish, since the colors of the yellow and blue dyes will then outweigh the color due to the red dye.

If, then, the furniture on the floor covering is rearranged, the areas of the floor covering which have faded due to exposure to light will adjoin areas of the floor covering which have not faded due to the shading by the furniture. The floor covering will thus subsequently have a nonuniform appearance, and this is undesirable.

This problem arises not just with floor coverings, but with any geometric structure, such as fibers, sheet materials or three-dimensionally formed articles.

It is an object of the present invention to provide polyamides for preparing fibers, sheetlike structures or moldings, especially yarns, which do not have the disadvantages mentioned and especially do not fade, and also processes whereby such polyamides may be prepared in a simple and economical manner.

For the purposes of the present invention, a system shall be deemed nonfading when, after its exposure in the form of a dyed yarn or carpet to an irradiation test as per DIN 75202 (May 1996 draft, exposure condition A as per Table 2 of this DIN), it exhibits no visible color change to the human eye compared with an unirradiated yarn or carpet with the same dyeing.

We have found that this object is achieved by the system defined at the beginning and also by a process for preparing such a system.

According to the invention, component a) of the system is obtained by polymerization of at least one monomer suitable for forming a polyamide and of a sterically hindered piperidine derivative having a functional group capable of amide formation with the polymer main chain of the polyamide.

Polyamides are herein to be understood as being homopolymers, copolymers, blends and grafts of synthetic long-chain polyamides having recurring amide groups in the polymer main chain as an essential constituent. Examples of such polyamides are nylon-6 (polycaprolactam), nylon-6,6 (polyhexamethyleneadipamide), nylon-4,6 (polytetramethyleneadipamide), nylon-6,10 (polyhexamethylenesebacamide), nylon-7 (polyenantholactam), nylon-11 (polyundecanolactam), nylon-12 (polydodecanolactam). As well as polyamides known by the generic name of nylon, polyamides further include the aramids (aromatic polyamides), such as poly-meta-phenyleneisophthalamide (NOMEX® fiber, U.S. Pat. No. 3,287,324) or poly-para-phenyleneterephthalamide (KEVLAR® fiber, U.S. Pat. No. 3,671,542).

Polyamides can in principle be prepared by two methods.

In a polymerization from dicarboxylic acids and diamines and also in a polymerization from amino acids or their derivatives, such as aminocarbonitriles, aminocarboxamides, aminocarboxylate esters or aminocarboxylate salts, the amino and carboxyl end groups of the starting monomers or starting oligomers react with one another to form an amide group and water. The water can subsequently be removed from the polymer. In a polymerization from carboxamides, the amino and amide end groups of the starting monomers or starting oligomers react with one another to form an amide group and ammonia. The ammonia can subsequently be removed from the polymer. This polymerization reaction is customarily known as a polycondensation.

A polymerization from lactams as starting monomers or starting oligomers is customarily known as a polyaddition.

Such polyamides are obtainable by conventional processes, described for example in DE-A-14 95 198, DE-A-25 58 480, EP-A-129 196 or in: Polymerization Processes, Interscience, New York, 1977, pages 424-467, especially pages 444-446, from monomers selected from the group consisting of lactams, omega-aminocarboxylic acids, omega-aminocarbonitriles, omega-aminocarboxamides, omega-aminocarboxylate salts, omega-aminocarboxylate esters, equimolar mixtures of diamines and dicarboxylic acids, dicarboxylic acid/diamine salts, dinitriles and diamines or mixtures thereof.

Useful monomers include

monomers or oligomers of a C₂ to C₂₀, preferably C₂ to C₁₈, arylaliphatic or, preferably, aliphatic lactam such as enantholactam, undecanolactam, dodecanolactam or caprolactam,

monomers or oligomers of C₂ to C₂₀, preferably C₃ to C₁₈, aminocarboxylic acids such as 6-aminocaproic acid or 11-aminoundecanoic acid, and dimers, trimers, tetramers, pentamers or hexamers thereof, and salts thereof such as alkali metal salts, for example lithium, sodium or potassium salts,

C₂ to C₂₀, preferably C₃ to C₁₈, aminocarboxylic acid nitriles such as 6-aminocapronitrile or 11-aminoundecanoic acid nitrile,

monomers or oligomers of C₂ to C₂₀ amino acid amides such as 6-aminocapramide or 11-aminoundecanamide, and dimers, trimers, tetramers, pentamers or hexamers thereof,

esters, preferably C₁-C₄ alkyl esters, such as methyl, ethyl, n-propyl, i-propyl, n-butyl, i-butyl or s-butyl esters, of C₂ to C₂₀, preferably C₃ to C₁₈, aminocarboxylic acids, such as 6-aminocaproic acid esters, for example methyl 6-aminocaproate, or 11-aminoundecanoic acid esters, for example methyl 11-aminoundecanoate,

monomers or oligomers of a C₂ to C₂₀, preferably C₂ to C₁₂, alkyldiamine, such as tetramethylenediamine or, preferably, hexamethylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof,

monomers or oligomers of a C₂ to C₂₀, preferably C₂ to C₁₂, alkyldiamine, such as tetramethylenediamine or, preferably, hexamethylenediamine,

with a C₈ to C₂₀, preferably C₈ to C₁₂, aromatic dicarboxylic acid or derivatives thereof, for example chlorides, such as naphthalene-2,6-dicarboxylic acid, preferably isophthalic acid or terephthalic acid,

and dimers, trimers, tetramers, pentamers or hexamers thereof,

monomers or oligomers of a C₂ to C₂₀, preferably C₂ to C₁₂, alkyldiamine, such as tetramethylenediamine or, preferably, hexamethylenediamine,

with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof, monomers or oligomers of a C₆ to C₂₀, preferably C₆ to C₁₀, aromatic diamine, such as m- or p-phenylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof, monomers or oligomers of a C₆ to C₂₀, preferably C₆ to C₁₀, aromatic diamine, such as m- or p-phenylenediamine,

with a C₈ to C₂₀, preferably C₈ to C₁₂, aromatic dicarboxylic acid or derivatives thereof, for example chlorides, such as naphthalene-2,6-dicarboxylic acid, preferably isophthalic acid or terephthalic acid,

and dimers, trimers, tetramers, pentamers or hexamers thereof, monomers or oligomers of a C₆ to C₂₀, preferably C₆ to C₁₀, aromatic diamine, such as m- or p-phenylenediamine,

with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof, monomers or oligomers of a C₇ to C₂₀, preferably CB to C₁₈, arylaliphatic diamine, such as m- or p-xylylenediamine,

with a C₂ to C₂₀, preferably C₂ to C₁₄, aliphatic dicarboxylic acid or mono- or dinitriles thereof, such as sebacic acid, dodecanedioic acid, adipic acid, sebacic acid dinitrile, decanoic acid dinitrile or adiponitrile,

and dimers, trimers, tetramers, pentamers or hexamers thereof, monomers or oligomers of a C₇ to C₂₀, preferably C₉ to C₁₈, arylaliphatic diamine, such as m- or p-xylylenediamine,

with a C₆ to C₂₀, preferably C₆ to C₁₀, aromatic dicarboxylic acid or derivatives thereof, for example chlorides, such as naphthalene-2,6-dicarboxylic acid, preferably isophthalic acid or terephthalic acid,

and dimers, trimers, tetramers, pentamers or hexamers thereof, monomers or oligomers of a C₇ to C₂₀, preferably C₉ to C₁₈, arylaliphatic diamine, such as m- or p-xylylenediamine, with a C₉ to C₂₀, preferably C₉ to C₁₈, arylaliphatic dicarboxylic acid or derivatives thereof, for example chlorides, such as o-, m- or p-phenylenediacetic acid,

and dimers, trimers, tetramers, pentamers or hexamers thereof, and homopolymers, copolymers, mixtures and grafts of such starting monomers or starting oligomers.

In a preferred embodiment, the lactam used is caprolactam, the diamine used is tetramethylenediamine, hexamethylenediamine or their mixtures and the dicarboxylic acid used is adipic acid, sebacic acid, dodecanedioic acid, terephthalic acid, isophthalic acid or mixtures thereof. Particular preference is given to the lactam being caprolactam, the diamine being hexamethylenediamine and the dicarboxylic acid being adipic acid or terephthalic acid or their mixtures.

Particular preference is given to those starting monomers or oligomers which on polymerization lead to the polyamides nylon-6, nylon-6,6, nylon-4,6, nylon-6,10, nylon-6,12, nylon-7, nylon-11 or nylon-12 or the aramids poly-meta-phenyleneisophthalamide or poly-para-phenyleneterephthalamide, especially to nylon 6 or nylon 66.

In a preferred embodiment, the polyamides may be prepared using one or more chain regulators. Useful chain regulators advantageously include compounds having one or more, such as two, three or four, preferably two in the case of systems in the form of fibers, amino groups reactive in polyamide formation or one or more, such as two, three or four, preferably two, in the case of systems in the form of fibers, carboxyl groups reactive in polyamide formation.

The first case provides polyamides wherein said monomers used for preparing said polyamide have a higher number of amine groups, or their equivalents, used for forming said polymer chain than carboxylic acid groups, or their equivalents, used for forming said polymer chain.

The second case provides polyamides wherein said monomers used for preparing said polyamide have a higher number of carboxylic acid groups, or their equivalents, used for forming said polymer chain than amine groups, or their equivalents, used for forming said polymer chain.

Useful chain regulators advantageously include monocarboxylic acids, such as alkanecarboxylic acids, for example acetic acid, propionic acid, such as benzene- or naphthalene-monocarboxylic acid, for example benzoic acid, dicarboxylic acids, such as C₄-C₁₀-alkanedicarboxylic acid, for example adipic acid, azelaic acid, sebacic acid, dodecanedioic acid, C₅-C₈-cycloalkanedicarboxylic acids, for example cyclohexane-1,4-dicarboxylic acid, benzene- or naphthalenedicarboxylic acid, for example terephthalic acid, isophthalic acid, naphthalene-2,6-dicarboxylic acid, C₂ to C₂₀, preferably C₂ to C₁₂, alkylamines, such as cyclohexylamine, C₆ to C₂₀, preferably C₆ to C₁₀, aromatic monoamines, such as aniline, or C₇ to C₂₀, preferably C₈ to C₁₈, arylaliphatic monoamines, such as benzylamine, diamines, such as C₄-C₁₀-alkanediamines, for example hexamethylenediamine.

The chain regulators may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano or halogens, such as fluorine, chlorine, bromine. Examples of substituted chain regulators are sulfoisophthalic acid and alkali or alkaline earth metal salts thereof, such as lithium, sodium or potassium salts, sulfoisophthalic esters, for example with C₁-C₁₆-alkanols, or sulfoisophthalic acid mono- or diamides, especially with monomers suitable for forming polyamides and bearing at least one amine group, such as hexamethylenediamine or 6-aminocaproic acid.

A chain regulator may advantageously be used in amounts of not less than 0.01 mol %, preferably not less than 0.05 mol %, especially not less than 0.2 mol %, based on 1 mol of acid amide groups of the polyamide.

A chain regulator may advantageously be used in amounts of not more than 1.0 mol %, preferably not more than 0.6 mol %, especially not more than 0.5 mol %, based on 1 mol of acid amide groups of the polyamide.

According to the invention, the polyamide as per component a) contains a sterically hindered piperidine derivative attached to the polymer chain by chemical bonding. The polyamide may also contain mixtures of such sterically hindered piperidine derivatives.

Preferred sterically hindered piperidine derivatives are those of the formula

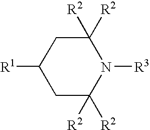

where

R¹ is a functional group capable of amide formation with the polymer chain of the polyamide, preferably a group —(NH)R⁵, in which R⁵ is hydrogen or C₁-C₈ alkyl, or a carboxyl group, or a carboxyl derivative, or a group —(CH₂)ₓ(NH)R⁵, in which x is 1 to 6 and R⁵ is hydrogen or C₁-C₈ alkyl, or a group —(CH₂)_{y}COOH, in which y is 1 to 6, or a —(CH₂)_{y}COOH acid derivative, in which y is 1 to 6, especially a group —NH₂,

R² is an alkyl group, preferably a C₁-C₄ alkyl group such as methyl, ethyl, n-propyl, i-propyl, n-butyl, i-butyl or s-butyl, especially a methyl group,

R³ is hydrogen, C₁-C₄ alkyl or O—R⁴, in which R⁴ is hydrogen or C₁-C₇ alkyl, R³ being hydrogen in particular

In such compounds, steric hindrance usually prevents the tertiary amino groups, and especially the secondary amino groups, of the piperidine ring system from reacting.

A particularly preferred sterically hindered piperidine derivative is 4-amino-2,2,6,6-tetramethylpiperidine.

The sterically hindered piperidine derivative may advantageously be used in amounts of not less than 0.01 mol %, preferably not less than 0.05 mol %, especially not less than 0.1 mol %, based on 1 mol of acid amide groups of the polyamide.

A compound (II) may advantageously be used in amounts of not more than 0.8 mol %, preferably not more than 0.6 mol %, especially not more than 0.4 mol %, based on 1 mol of acid amide groups of the polyamide.

In a preferred embodiment, the polymerization in the process of the invention is carried out in the presence of at least one pigment. Preferred pigments are titanium dioxide, preferably titanium dioxide in the anatase modification, or coloring compounds of inorganic or organic nature. The pigments are preferably added in an amount of from 0 to 5 parts by weight, especially from 0.02 to 2 parts by weight, based on 100 parts by weight of polyamide. The pigments may be added to the reactor together with the starting materials or separately therefrom.

Polyamides advantageously useful as component a), which contain a sterically hindered piperidine derivative attached to the polymer chain by chemical bonding, and processes for the preparation of said polyamides are described for example in WO 95/28443, WO 97/05189, WO 98/50610, WO 99/46323, WO 99/48949, EP-A-822 275, EP-A-843 696 and the German applications 10030515.6, 10030512.1 and 10058291.5.

According to the invention, component a) is admixed with a 2,6-diaminopyridine derivative as component b).

Component b) is advantageously a 2,6-diaminopyridine derivative of the formula

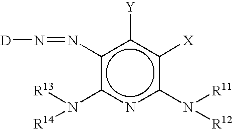

R¹¹ and R¹³ may independently be hydrogen or an aliphatic group, a cycloaliphatic group, an aromatic/aliphatic group or an aromatic group.

An aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

As cycloaliphatic group may advantageously be cyclopentyl, cyclohexyl, cycloheptyl, cyclooctyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

An aromatic/aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl, which bears an aromatic group. For the purposes of the present invention, an aromatic group is a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

An aromatic group may advantageously be a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

R¹² and R¹⁴ may independently be hydrogen or an aliphatic group, a cycloaliphatic group, an aromatic/aliphatic group or an aromatic group. Preferably R² and R⁴ may independently be an aliphatic group, a cycloaliphatic group, an aromatic/aliphatic group or an aromatic group.

An aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

A cycloaliphatic group may advantageously be cyclopentyl, cyclohexyl, cycloheptyl, cyclooctyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

An aromatic/aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl, which bears an aromatic group. For the purposes of the present invention, an aromatic group is a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

An aromatic group may advantageously be a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic 40 groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

The radicals R¹¹ and R¹² or R¹³ and R¹⁴ may combine with the respective nitrogen to form a ring system, such as pyrrolidine, piperidine, morpholine or (N-alkyl)piperazine, such as N-methylpiperazine.

In a preferred embodiment, R¹¹ and R¹³ are each hydrogen and R¹² and R¹⁴ are independently 2-hydroxyethyl, 3-hydroxy-n-propyl, 2-methoxy-ethyl, 3-methoxy-n-propyl, 2-phenyl-ethyl, 2-(p-phenylsulfonic acid)-ethyl, 2-(sodium p-phenylsulfonate)-ethyl, phenyl.

The radical X may advantageously be a cyano, carboxamide or carboxylate group.

The carboxamide or carboxylate group may be unsubstituted or substituted, for example by an aliphatic group, a cycloaliphatic group, an aromatic/aliphatic group or an aromatic group.

An aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

A cycloaliphatic group may advantageously be cyclopentyl, cyclohexyl, cycloheptyl, cyclooctyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

An aromatic/aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl, which bears an aromatic group. For the purposes of the present invention, an aromatic group is a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably. C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

An aromatic group may advantageously be a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

In a preferred embodiment, X is cyano.

Y may be hydrogen or an aliphatic group, a cycloaliphatic group, an aromatic/aliphatic group or an aromatic group.

An aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, halogens, such as fluorine, chlorine or bromine, or be interrupted by heteroatoms, such as oxygen, nitrogen or sulfur.

A cycloaliphatic group may advantageously be cyclopentyl, cyclohexyl, cycloheptyl, cyclooctyl. This group may be unsubstituted or substituted, for example by halogen, OH, ═O, C₁-C₈-alkoxy, COOH, C₂-C₆-carbalkoxy, C₁-C₁₀-acyloxy or C₁-C₈-alkylamino, or be interrupted by heteroatoms, such as oxygen, nitrogen or sulfur.

An aromatic/aliphatic group may advantageously be a C₁-C₈-alkyl group, such as methyl, ethyl, i-propyl, n-propyl, n-butyl, i-butyl, s-butyl, n-pentyl, n-hexyl, n-heptyl, n-octyl, 2-ethyl-hexyl, which bears an aromatic group. For the purposes of the present invention, an aromatic group is a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

An aromatic group may advantageously be a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine. Advantageous examples of a basic skeleton for an aromatic group are benzene, naphthalene, biphenyl, azobenzene, thiophene, benzothiazole, benzisothiazole, thiazole, thiadiazole, triazole, benzotriazole, indazole, pyrazole and anthraquinone.

In a preferred embodiment, Y is methyl.

D is an aromatic group.

An aromatic group may advantageously be a fully conjugated cyclopolyene having (4n+2) pi-electrons, where n is a natural number including zero, such as 0, 1, 2 or 3. The cyclopolyene may be constructed of a pure carbon skeleton or contain one or more, such as 2, 3 or 4, heteroatoms, for example oxygen, nitrogen or sulfur. The aromatic groups may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine, or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine.

Advantageous examples of a basic skeleton for an aromatic group are benzene, naphthalene, biphenyl, azobenzene, thiophene, benzothiazole, benzisothiazole, isothiazole, thiazole, thiadiazole, triazole, benzotriazole, indazole, pyrazole and anthraquinone.

In a preferred embodiment, the basic skeleton of D is selected from benzene, naphthalene, biphenyl, azobenzene, thiophene, benzthiazole, benzisothiazole, isothiazole, thiazole, thiadiazole, triazole, benzotriazole, indazole, pyrazole and anthraquinone, especially benzene, which groups may be singly or multiply, such as doubly or triply, substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine or particularly preferably by an azo-attached aromatic group, such as benzene, naphthalene, biphenyl, azobenzene, thiophene, benzothiazole, benzisothiazole, isothiazole, thiazole, thiadiazole, triazole, benzotriazole, indazole, pyrazole and anthraquinone, especially benzene, which group may be singly or multiply, such as doubly or triply, substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid or salts thereof, such as alkali or alkaline earth metal salts, cyano, halogens, such as fluorine, chlorine, bromine or a further aromatic group which for its part may be unsubstituted or substituted, for example by aliphatic groups, preferably C₁-C₈-alkyl groups, such as methyl, ethyl, i-propyl, n-propyl, n-butyl, i-butyl, s-butyl, n-pentyl, n-hexyl, n-heptyl, n-octyl, 2-ethyl-hexyl, OH, ═O, C₁-C₈-alkoxy, COOH, C₂-C₆-carbalkoxy, C₁-C₁₀-acyloxy, or C₁-C₈-alkylamino, sulfonic acid of salts thereof, such as alkali or alkaline earth metal salts, cyano, halogens, such as fluorine, chlorine and bromine.

In a preferred embodiment, the 2,6-diaminopyridine derivative may be an acidic compound. For the purposes of the present invention, an acidic compound is a compound having a pH of less than 7 in aqueous solution, or a salt of such a compound, for example, the sodium or potassium salt, or mixtures thereof. The acidic property of the 2,6-diaminopyridine derivative is preferably obtainable by the compound containing one or more, such as 2, 3 or 4, sulfonic acid groups or salts thereof, such as sodium or potassium salts, or mixtures thereof.

Compounds useful as component b) are known for example from BE-A-793316, BE-A-793317, BE-A-811640, DE-A-19623411, DE-A-19706245, DE-A-2062717, DE-A-2156545, DE-A-2211663, DE-A-2216570, DE-A-2222099, DE-A-2222873, DE-A-2234621, DE-A-2263458, DE-A-2306673, DE-A-2308663, DE-A-2315637, DE-A-2361371, DE-A-2362581, DE-A-2404854, DE-A-2419763, DE-A-2507863, DE-A-2640576, DE-A-2701610, DE-A-2718619, DE-A-2718620, DE-A-2718883, DE-A-2832020, DE-A-2916319, DE-A-3025904, DE-A-3111937, DE-A-3227134, DE-A-3227253, DE-A-3235640, DE-A-3330155, DE-A-3615093, DE-A-3634393, DE-A-3707715, DE-A-3723884, DE-A-3820313, DE-A-4207745, DE-A-4215535, DE-A-4321422, DE-A-4329915, EP-A-474600, EP-A-512548, EP-A-581730, EP-A-581731, EP-A-581732, EP-A-601439, JP-A-59075952, JP-A-59140265, JP-A-59168193, JP-A-61075885, JP-A-61151269, JP-A-63085187, JP-A-05096869, JP-A-05124364, NL-A-7303378, NL-A-7402043, NL-A-7502419.

Component b) may be a single compound or a mixture of multiple compounds, such as two, three or four.

Component b) may be a colored or colorless compound. When component b) is a colored compound, the desired color may be obtained by one compound or by multiple compounds, such as two, three or four, especially three, preferably of different colors.

The system is obtained according to the invention by admixing component a) with component b).

A system is contemplated where component a) and component b) are present in a mixture. Similarly contemplated is a system wherein component b) is present on the surface of component a).

To prepare a system wherein component a) and component b) are present in a mixture, component b) can be incorporated into component a) by conventional processes, for example by extrusion, such as melt extrusion. The system may then be processed in a conventional manner into geometric structures, such as filaments, for example by spinning from the melt, films, for example by the blow-stretch process, or three-dimensionally formed articles, for example by injection molding.

To prepare a system wherein component b) is present on the surface of component a), the first step is to prepare geometric structures, such as filaments, for example by spinning from the melt, films, for example by the blow-stretch process, or three-dimensionally formed articles, for example by injection molding, and then to apply component b), preferably by applying a solution of component b), especially in water or an organic solvent, for example by immersing the geometric structure in the solution.

When component b) is applied to a geometric structure formed from component a), a portion of component b) may diffuse into the geometric structure formed from component a).

After component b) has been applied to the geometric structure formed from component a), a heat treatment in the presence or absence of water vapor may be used to stabilize the spatial form of the system.

### EXAMPLES

The relative solution viscosity of the polyamide was measured in 96% sulfuric acid as per DIN 51562-1 to −4.

To this end, 500 mg of the sample were weighed into a 50 ml volumetric flask and made up to 96% by weight sulfuric acid. The sample was dissolved to give a homogeneous solution.

An Ubbelohde No. II viscometer was used to determine the flow time between the upper and lower calibration marks at 25° C.±0.05° C. The measurements were repeated until three successive measurements fell within a 0.3 second range. The flow time for the solvent was determined in the same way. The relative solution viscosity (RV) was determined according to

RV=T/T₀

where: T is the flow time of the solution [seconds]

T₀ is the flow time of the solvent [seconds]

The number of amino end groups was determined by titrating a solution of 1 g of polyamide in 25 ml of a 7:3 w/w phenol-methanol mixture with a solution of perchloric acid in methanol/ethylene glycol (1.72 ml of a 70% by weight aqueous solution, 100 ml of methanol, made up to 1000 ml in ethylene glycol) against a mixture of 0.1 g of benzyl orange in 100 ml of methanol and 0.05 g of methylene blue in 50 ml of methanol as an indicator. The amino end group number was determined in milliequivalents of amino end groups per kg of polyamide.

Polyamide 1 used according to the invention was a nylon-6 containing 0.12% by weight (based on polyamide) of 4-amino-2,2,6,6-tetramethylpiperidine attached to the polymer chain by chemical bonding and having a relative viscosity of 2.77 and an amino end group number of 34 meq/kg.

Comparative polyamide 1 was a nylon-6,6 having a relative viscosity of 2.80 and an amino end group number of 44 meq/kg. Inventive polyamide 1 and comparative polyamide 1 contained 0.3% by weight, based on polyamide, of titanium dioxide. Inventive polyamide 1 and comparative polyamide 1 were processed in the form of staple fibers (round cross section, linear density 60% of 6.7 dtex/40% of 13 dtex for inventive polyamide 1, 60% of 6.7 dtex/40% of 11 dtex for comparative polyamide 1) wrapped yarn, metric count 8, into a pile carpet using a 1/10″ gauge, 54 stitches/10 cm and a pile weight of 260 g/m².

The inventive 2,6-diaminopyridine derivative 1 was Acidol Red GL-XN (Nylonmin C-GL) (BASF Aktiengesellschaft) of the formula

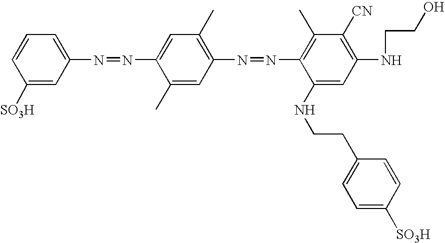

The red comparative dye 1 was Telon Red FR-L (Bayer AG), C.I. Acid Red 337, of the formula

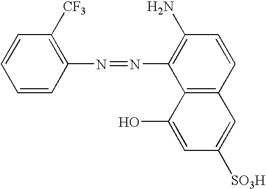

These two red dyes were used together with the noninventive dyes Telon Blue CGL and Telon Yellow RLN in the case of trichromat 1 and Tectilon Blue 4R and Acidol Brillant Yellow M3GL in the case of trichromat 2 to obtain an inventive trichromat 1 and/or inventive trichromat 2 and a comparative trichromat 1 to give a dark gray hue on inventive polyamide 1 and comparative polyamide 1.

The dyeing was carried out in a laboratory autoclave at 90° C. in such a way that the same visual color impression (same gray hue) was obtained in the case of the combinations of inventive polyamide 1/inventive trichromat 1 and/or 2, comparative polyamide 1/inventive trichromat 1 and/or 2, inventive polyamide 1/comparative trichromat 1 and comparative polyamide 1/comparative trichromat 1.

The carpets were subjected to three cycles of the test described in DIN 75202 (May 1996 draft), exposure condition A as per Table 2 of this DIN, and the changes were determined as CIELAB Delta L, CIELAB Delta E (CIELAB as per Ullmann's Encyclopedia of Industrial Chemistry, 5th ed., vol. A9, VCH Verlagsgesellschaft, Weinheim, Germany, 1987, pages 102-104, sections 3.4. and 3.5.) and as the gray scale as per the aforementioned DIN 75202, Point 5.2.5 after every cycle.

The tests provided the following values:

CIELAB Delta L

The smaller the CIELAB Delta L values, the less the carpet has faded.

TABLE 1

| | | CIELAB Delta L | | |
|---|---|---|---|---|
| | | 1st | 2nd | 3rd |
| Polyamide | Trichromat | cycle | cycle | cycle |
| Inventive polyamide 1 | Inventive trichromat 1 | 1.4 | 4.6 | 10.1 |
| Inventive polyamide 1 | Inventive trichromat 2 | 2.9 | 5.9 | 8.8 |
| Inventive polyamide 1 | Comparative | 7.0 | 10.2 | 12.7 |
| | trichromat 1 | | | |
| Comparative polyamide 1 | Inventive trichromat 1 | 5.5 | 13.3 | 21.9 |
| Comparative polyamide 1 | Inventive trichromat 2 | 5.3 | 11.9 | 19.8 |
| Comparative polyamide 1 | Comparative | 9.3 | 17.1 | 20.7 |
| | trichromat 1 | | | |

The best values were obtained with the system according to the invention.

CIELAB Delta E

The smaller the CIELAB Delta E values, the less the carpet has faded.

TABLE 2

| | | CIELAB Delta E | | |
|---|---|---|---|---|
| | | 1st | 2nd | 3rd |
| Polyamide | Trichromat | cycle | cycle | cycle |
| Inventive polyamide 1 | Inventive trichromat 1 | 2.8 | 5.5 | 10.6 |
| Inventive polyamide 1 | Inventive trichromat 2 | 3.1 | 5.9 | 8.8 |
| Inventive polyamide 1 | Comparative | 12.4 | 17.1 | 19.6 |
| | trichromat 1 | | | |
| Comparative polyamide 1 | Inventive trichromat 1 | 6.3 | 14.2 | 22.4 |
| Comparative polyamide 1 | Comparative | 6.0 | 12.6 | 20.3 |
| | trichromat 2 | | | |
| Comparative polyamide 1 | Comparative | 12.6 | 20.2 | 22.8 |
| | trichromat 1 | | | |

The best values were obtained with the system according to the invention.

Gray Scale

The higher the values on the gray scale, the less the carpet has faded. The best value is 5 (equivalent to unfaded), the smallest value is 1 (equivalent to completely faded).

TABLE 3

| | | Gray scale | | |
|---|---|---|---|---|
| | | 1st | 2nd | 3rd |
| Polyamide | Trichromat | cycle | cycle | cycle |
| Inventive polyamide 1 | Inventive trichromat 1 | 3-4 | 2 | 1-2 |
| Inventive polyamide 1 | Inventive trichromat 2 | 3 | 2 | 1-2 |
| Inventive polyamide 1 | Comparative trichromat 1 | 1 | 1 | 1 |
| Comparative | Inventive trichromat 1 | 2 | 1 | 1 |
| polyamide 1 | | | | |
| Comparative | Comparative Trichromat 2 | 2 | 1 | 1 |
| polyamide 1 | | | | |
| Comparative | Comparative Trichromat 1 | 1 | 1 | 1 |
| polyamide 1 | | | | |

The best values were obtained with the system according to the invention.

Visual Assessment

The carpets used (inventive polyamide 1/inventive trichromat 1 and/or inventive trichromat 2, comparative polyamide 1/inventive trichromat 1 and/or inventive trichromat 2, inventive polyamide 1/comparative trichromat 1 and comparative polyamide 1/comparative trichromat 1) has visually the same dark gray hue prior to the first cycle.

Inventive trichromat 2 gave a more uniform color impression prior to the first cycle, while inventive trichromat 1 produced a slight dichroism, ie because of the different exhaustion of the red dye as compared with the blue and yellow dyes there were reddishly and greenishly shimmering patches on the surface of the carpet.

The combination of comparative polyamide 1/comparative trichromat 1 exhibited distinct greening and distinct bleaching after the third cycle.

The combination of inventive polyamide 1/comparative trichromat 1 exhibited slight greening and distinct bleaching after the third cycle.

The combination of comparative polyamide 1/inventive trichromat 1 and/or inventive trichromat 2 exhibited no greening and distinct bleaching after the third cycle.

The combination of inventive polyamide 1/inventive trichromat 1 and/or inventive trichromat 2 exhibited no greening and minimal bleaching after the third cycle.

The best visual results were obtained with the system according to the invention.

We claim:

1. A system comprising
a) a polyamide containing a sterically hindered piperidine derivative attached to the polymer chain by chemical bonding, and
b) a 2,6-diaminopyridine derivative.

2. A system as claimed in claim 1, wherein the piperidine derivative used is a piperidine derivative of the formula 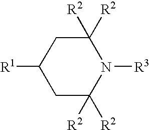
where
R¹ is a functional group capable of amide formation with the polymer chain of the polyamide,
R² is an alkyl group, and
R³ is hydrogen, C₁-C₄-alkyl or O—R⁴, in which R⁴ is hydrogen or C₁-C₇-alkyl.

3. A system as claimed in claim 2, wherein R¹ is a group —(NH)R⁵, where R⁵ is hydrogen or C₁-C₈-alkyl, or is a carboxyl group or a carboxyl derivative or a group —(CH₂)ₓ(NH)R⁵, where x is from 1 to 6 and R⁵ is hydrogen or C₁-C₈-alkyl, or a group —(CH₂)_{y}COOH, where y is from 1 to 6, or a —(CH₂)_{y}COOH acid derivative, where y is from 1 to 6.

4. A system as claimed in claim 2 or 3, wherein R¹ is NH₂.

5. A system as claimed in any of claims 2 to 4, wherein R² is methyl.

6. A system as claimed in any of claims 1 to 5, wherein the piperidine derivative used is 4-amino-2,2,6,6-tetramethylpiperidine.

7. A system as claimed in any of claims 1 to 6, wherein component b) is a 2,6-diaminopyridine derivative of the formula 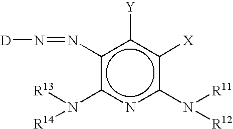
where
R¹¹ and R¹³ are independently hydrogen or an aliphatic, cycloaliphatic, aromatic/aliphatic or aromatic group,
R¹² and R¹⁴ are independently an aliphatic, cycloaliphatic, aromatic/aliphatic or aromatic group,
and R¹¹ and R¹² or R¹³ and R¹⁴ may combine with the respective nitrogen to form a ring system,
X is a cyano, carboxamide or carboxylate group,
Y is hydrogen or an aliphatic group, a cycloaliphatic group, an aromatic/aliphatic group or an aromatic group, and
D is an aromatic group.

8. A system as claimed in claim 7, wherein D is selected from the group consisting of benzene, naphthalene, biphenyl, azobenzene, thiophene, benzothiazole, benzisothiazole, thiazole, thiadiazole, triazole, benzotriazole, indazole, pyrazole and anthraquinone.

9. A system as claimed in any of claims 1 to 8, wherein component b) is present on the surface of component a).

10. A system as claimed in any of claims 1 to 8, wherein component a) and component b) are present as a mixture.

11. A system as claimed in any of claims 1 to 10 in the form of a fiber.

12. A system as claimed in any of claims 1 to 10 in the form of a sheetlike structure.

13. A system as claimed in any of claims 1 to 10 in the form of a molding.

14. A process for preparing a system as claimed in any of claims 1 to 13, which comprises preparing a component a) by polymerization of at least one monomer suitable for forming a polyamide and of a sterically hindered piperidine derivative comprising a functional group capable of amide formation with the polymer main chain of the polyamide and then admixing component a) with a 2,6-diaminopyridine derivative as a component b).
